(19) United States
(12) Patent Application Publication
(10) Pub. No.: US 2022/0247483 A1
(43) Pub. Date: Aug. 4, 2022

(54) ROBUST SATELLITE COMMUNICATION

(71) Applicant: Rockwell Collins, Inc., Cedar Rapids, IA (US)

(72) Inventors: John V. Thommana, Cedar Rapids, IA (US); Jeffrey Grundmeyer, Walker, IA (US); Syed A. Ahmed, Iowa City, IA (US)

(21) Appl. No.: 17/162,834

(22) Filed: Jan. 29, 2021

(51) Int. Cl. H04B 7/185; H04L 5/14; H04B 1/707

(52) U.S. Cl. CPC H04B 7/18513; H04B 1/707; H04L 5/14

(57) ABSTRACT

Embodiments of the present disclosure are directed to a jam resistant signal. The signal is transmitted from a terminal to a satellite. The signal may include two waveform components. The first waveform component includes a Frequency Division Duplex (FDD) wideband Direct Spread Spectrum (DSSS) waveform. The FDD wideband DSSS waveform may include one or more spectrally notched portions. At least one of the spectrally notched portions may be for the second waveform component. The second waveform component includes an FDD narrowband waveform.

### TECHNICAL FIELD

The present invention generally relates to communication systems, and more specifically to a jamming resistant communication.

### BACKGROUND

Ultra-High Frequency (UHF) Satellite Communications (Satcom) waveforms are used by the military in contested theaters. These UHF waveforms may include Frequency Division Duplex (FDD) wideband Direct Sequence Spread Spectrum (DSSS) waveforms and Frequency Division Duplex (FDD) narrowband waveforms. However, such wideband waveforms and narrowband waveforms may be deniable. There is a need for spectrum access resiliency, for transmitting and receiving despite interference/denial, for disrupting adversarial attempts to deny spectrum, and for regaining lost access to spectrum.

Therefore, it would be advantageous to provide a device, system, and method that cures the shortcomings described above.

### SUMMARY

A method of transmitting information is disclosed, in accordance with one or more embodiments of the present disclosure. In one illustrative embodiment, the method includes spectrally notching, by a terminal, a Frequency Division Duplex (FDD) narrowband transmit channel in a FDD wideband Direct Sequence Spread Spectrum (DSSS) transmit channel. In another illustrative embodiments, the method includes transmitting a signal from the terminal to a spot beam of a satellite, the signal transmitted from the terminal to the spot beam including an FDD narrowband waveform in the narrowband transmit channel and an FDD wideband DSSS waveform in the FDD wideband DSSS transmit channel, wherein the FDD narrowband waveform and the FDD wideband DSSS waveform each include redundant data for improving a jam resistance of the signal.

A system is disclosed, in accordance with one or more embodiments of the present disclosure. In one illustrative embodiment, the system includes a Frequency Division Duplex (FDD) wideband Direct Sequence Spread Spectrum (DSSS) waveform in a FDD wideband DSSS transmit channel, the FDD wideband DSSS transmit channel including a FDD narrowband transmit channel generated by spectral notching. In another illustrative embodiment, the system includes a FDD narrowband waveform in the FDD narrowband transmit channel of the FDD wideband DSSS transmit channel. In another illustrative embodiment, the system includes, a first platform including a terminal, the terminal of the first platform configured to transmit the FDD wideband DSSS waveform in the FDD wideband DSSS transmit channel and spectrally notch the FDD narrowband transmit channel in the FDD wideband DSSS transmit channel. In another illustrative embodiment, the system includes a second platform including a terminal, the terminal of the second platform configured to transmit the FDD narrowband waveform in the FDD narrowband transmit channel. In another illustrative embodiment, the FDD wideband DSSS waveform and the FDD narrowband waveform include redundant data.

### BRIEF DESCRIPTION OF THE DRAWINGS

Implementations of the concepts disclosed herein may be better understood when consideration is given to the following detailed description thereof. Such description makes reference to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1 depicts a system, in accordance with one or more embodiments of the present disclosure;

FIG. 2A depicts one or more ground stations of the system, in accordance with one or more embodiments of the present disclosure;

FIG. 2B depicts a routing of the system, in accordance with one or more embodiments of the present disclosure;

FIGS. 3A-3B depict a transmit obfuscation technique, in accordance with one or more embodiments of the present disclosure;

FIG. 4 depicts a receive obfuscation technique, in accordance with one or more embodiments of the present disclosure;

FIG. 5 depicts a system, in accordance with one or more embodiments of the present disclosure; and

FIG. 6 depicts a method, in accordance with one or more embodiments of the present disclosure.

### DETAILED DESCRIPTION OF THE INVENTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1 b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

Reference will now be made in detail to the subject matter disclosed, which is illustrated in the accompanying drawings.

In embodiments, at least one Frequency Division Duplex (FDD) narrowband waveform (hereafter narrowband waveform) may be transmitted currently with at least one FDD wideband Direct Sequence Spread Spectrum (DSSS) waveform (hereafter wideband waveform) in a FDD wideband DSSS channel (hereafter a wideband channel). The at least one narrowband waveform may act as a narrowband interferer to the concurrently transmitted wideband waveform, but within interference rejection capabilities of the wideband waveform. Thus, the narrowband waveform and the wideband waveform may simultaneously transmit data. The wideband waveform and the narrowband waveform may further communicate (e.g., transmit and/or receive) the same data. By communicating the same data, the wideband waveform and the narrowband waveform may be made redundant. Such redundant communications may include jam resistant properties described further herein. One or more obfuscation techniques may also be used to prevent targeting of the wideband waveform and/or the narrowband waveform.

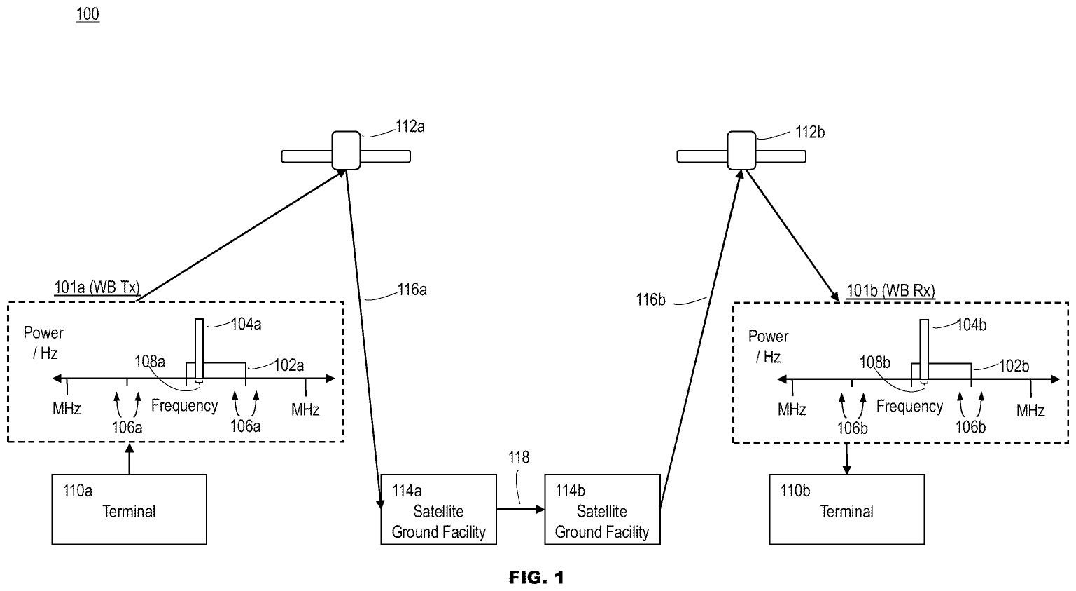

FIG. 1 depicts a double-hop communication system 100, in accordance with one or more embodiments of the present disclosure.

Generally, a signal may be transmitted 101a (WB Tx) from a terminal 110a to a satellite 112a, transmitted from the satellite 112a to an additional satellite 112b by a ground hop, and transmitted from the additional satellite 112b to an additional terminal 110b. As depicted in FIG. 1, the system 100 may operate narrowband waveforms 104 concurrent with wideband waveforms 102 over satellite spot beams. Such spot beams may support narrowband communication in a frequency band (e.g., transmit and/or receive). Such spot beams may have a narrower antenna beam width with a higher gain (e.g., as compared to a Satcom system with a hemispherical antenna beam). Thus, an Effective Isotropic Radiated Power (EIRP) required of the narrowband communication may be reduced by the higher spot beam antenna gain. In embodiments, the narrowband waveform 104 may include a Demand Assigned Multiple Access and Integrated Waveform (DAMA/IW) waveform. The DAMA/IW waveform may have two variant waveform protocols, a 5 kHz bandwidth and a 25 kHz bandwidth, and are governed by various military standards, such as MIL-STD-188-181, MIL-STD-188-182, and MIL-STD-188-183. In embodiments, the wideband waveform 102 may include a Mobile User Objective System (MUOS) waveform. The MUOS waveform may include a channel bandwidth of 5 MHz with a transmit frequency plan from 360 MHz to 380 MHz and a receive frequency plan from 300 MHz to 320 MHz.

The wideband waveform and the narrowband waveform may be concurrently transmitted in a wideband channel of the spot beam, such as a wideband transmit channel 106a or a wideband receive channel 106a. The instantaneous channel bandwidth of the wideband waveform may be 5 MHz or more and the instantaneous channel bandwidth of the narrowband waveform may be 25 kHz or more. Typically, the narrowband waveform and wideband waveform are operated with different spectrum allocations to prevent interference between the two. The FDD spectrum allocations for each waveform includes a 20 MHz or more allocation for transmission and reception where the transmit and receive bands are separated in frequency. The spectrum allocation may be in UHF or higher bands.

A Direct Sequence Spread Spectrum System and Method Thereof is described in U.S. Pat. No. 7,940,831, to Thommana, which is incorporated herein by reference in its entirety.

The wideband waveform 102 may be resilient to narrowband interferers. For example, the wideband waveform 102 may include an interference mitigation process to prevent interfering with important local narrowband waveforms operating in the wideband transmit channels 106a or the wideband receive channels 106b. The interference mitigation process may include spectral notching. By the spectral notching, the wideband waveform 102 may minimally interfere with local narrowband waveforms operating in the wideband band channel (e.g., receive or transmit). Such spectral notching may further be performed in accordance with one or more Host Nation Agreements.

In embodiments, the spectral notching capability of the wideband waveform 102 may be used to spectrally notch at least one narrowband channel 108 (e.g., narrowband transmit channel 108a or narrowband receive channel 108b) in the wideband channel 106 (e.g., wideband transmit channel 106a or wideband receive channel 106b). For example, the narrowband channels 108 may have a bandwidth of 25 kHz and the wideband channel 106 may have a bandwidth of 5 MHz, such that each wideband channel 106 may include from 1 to 200 narrowband channels. By way of another example, the narrowband channels 108 may have a bandwidth of 5 kHz and the wideband channel 106 may have a bandwidth of 5 MHz, such that each wideband channel 106 may include from 1 to 1000 narrowband channels. The number of narrowband channels 108 spectrally notched in the wideband channel 106 may be reduced to both comply with host nation agreements and to ensure sufficient wideband link margin (LKM) and data rates. In embodiments, between 10 to 20 narrowband channels may be spectrally notched in the wideband channel 106, although this is not intended to be limiting. Furthermore, the narrowband channels 108 may be notched in any portion of the wideband channel 106. In this regard, each wideband channel 106 may include a plurality of narrowband channels 108 which may be spectrally notched for transmitting a narrowband waveform 104 concurrently with the wideband waveform 102. Where the wideband channel 106 includes a bandwidth greater than 5 MHz, additional narrowband channels 108 may be supported in the wideband channel 106. Where the wideband channel 106 includes a bandwidth greater than 5 MHz, additional narrowband channels 108 may be supported in the wideband channel 106. In this regard, the narrowband waveform 102 may include any suitable FDD narrowband waveform. For example, the narrowband channel 108 may generally be spectrally notched from a portion of the wideband channel 106, the portion including a bandwidth of 500 kHz or less.

In embodiments, a narrowband waveform 104 may be transmitted in the narrowband channel 108 which has been spectrally notched from a wideband channel 106 (wideband transmit channel 106a or wideband receive channel 108b).

The data transmitted by the narrowband waveform 104 and the wideband waveform 102 may be redundant (e.g., the same data). By concurrently transmitting redundant data by way of the wideband waveform 102 together with the narrowband waveform 104 in the wideband channel 106, an increase in one or more of a time, a bandwidth, or an effective isotropic radiated power (EIRP) may be required to prevent the data transmission. In this regard, to effectively jam the data transmission an enemy must determine whether the narrowband waveform 104 corresponds to the wideband waveform 102, and upon determining such correspondence utilize a wideband jamming technique to jam the full wideband channel 106 (thereby blocking the wideband waveform 102) and utilize a narrowband jamming technique to jam the narrowband channel 108 portion of the wideband channel 106 (thereby blocking the narrowband waveform 104). This two-part jamming technique is required, at least in part, because the narrowband waveform 104 may have a higher power as compared to the wideband waveform 102, such that conventional wideband jamming techniques are ineffective against the narrowband waveform 104; and because the wideband waveform 102 is a spread-spectrum waveform, such that conventional narrowband jamming techniques are ineffective against the wideband waveform 102. Furthermore, the enemy must target both the wideband channels as well as the narrowband channel to prevent the data transmission and/or reception because the wideband waveform 102 and the narrowband waveform may communicate the same data. Although the various figures herein depict a single wideband waveform 102 in the wideband channel 106, this is not intended as a limitation on the present disclosure. In this regard, there may be a plurality of wideband waveforms 102 in the wideband channel 106, each of the plurality separated by a unique spreading code, together with one or more narrowband waveforms 104. In embodiments, the plurality of wideband waveforms 102 may include non-redundant data, for improving a data rate of the signal.

In embodiments, a terminal 110 (e.g., terminal 110a, terminal 110b) may be configured to concurrently transmit and/or receive the wideband waveform 102 and the narrowband waveform 104 in the wideband channel 106. Operating narrowband Satcom (e.g., narrowband waveform 104) in the wideband channel 106 together with the wideband waveform 104 from the terminal 110 may require the terminal 110 to include either two Power Amplifiers (PAs) or a very high power, very linear power amplifier. The terminal 110 may comprise any suitable terminal, such as, but not limited to, a UHF Satcom radio terminal.

For example, a transmit signal 101a (Tx) may be transmitted form the terminal 110a to the satellite 112a. The transmit signal 101a may include the wideband transmit waveform 102a and the narrowband transmit waveform 104a transmitted together in a wideband transmit channel 106a. The narrowband transmit waveform 104a may be transmitted in the narrowband transmit channel 108a which has been spectrally notched from a portion of the wideband transmit channel 106a.

By way of another example, a receive signal 101b (Rx) may be transmitted from the satellite 112b to the terminal 110b. The receive signal 101b may include the wideband receive waveform 102b and the narrowband receive waveform 104b received together in a wideband receive channel 106b. The narrowband receive waveform 104b may be transmitted in a narrowband receive channel 108b which has been spectrally notched from a portion of the wideband receive channel 106b.

The system 100 may further include a Ka band downlink transmission 116a from the satellite 112a to a satellite ground facility 114a, a routing 118 from the satellite ground facility 114a to a satellite ground facility 114b, and a Ka band uplink transmission 116b from the satellite ground facility 114b to the satellite 112b.

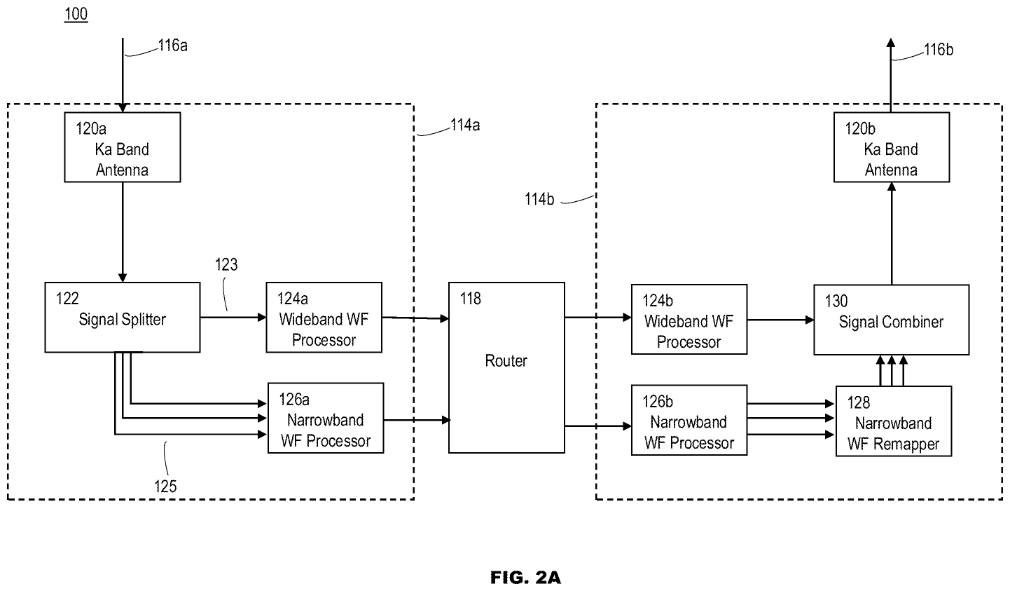

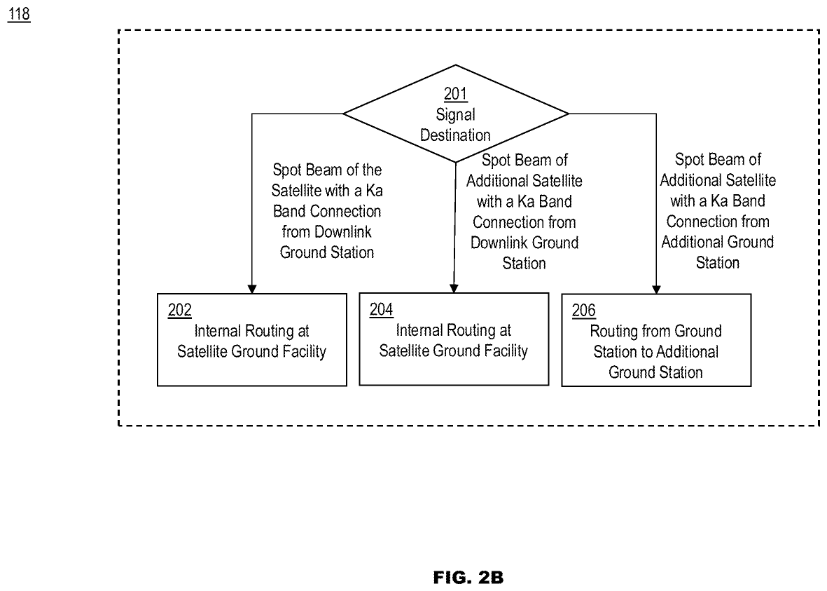

FIGS. 2A-2B further depict the system 100, in accordance with one or more embodiments of the present disclosure.

The satellite 112 (e.g., satellite 112a or satellite 112b) may generally be a dual waveform satellite configured to host narrowband and wideband waveforms together in a wideband channel. The satellite 112 may include 16 spot beams with each spot beam having 4 wideband transmit channels and 4 wideband receive channels. There may be no interference between the spot beams, because each spot beam may be assigned to a different coverage area. The satellite 112 may be configured to transmit signals to and from the satellite ground facility 114 by the Ka band transmission 116 (e.g., Ka band downlink transmission 116a or Ka band uplink transmission 116b). The Ka band transmission 116 may include a transmission in a portion of the electromagnetic spectrum having a frequency from 26 to 40 GHz. As may be understood, the satellite 112 (e.g., satellite 112a or satellite 112b) may include any current or future satellite, such as, but not limited to a MUOS satellite.

The satellite ground facility 114a may be configured to independently process each wideband receive channel 106a related to a spot beam of the satellite 112a. In embodiments, the satellite ground facility 114a may include at least a Ka band antenna 120a, a signal splitter 122, at least one wideband waveform processor 124a, and at least one narrowband waveform processor 126a. The satellite ground facility 114a may receive the Ka band downlink transmission 116a from the satellite 112a by the Ka band antenna 120a. A signal from the Ka band antenna 120a may be communicated to a signal splitter 122. The signal splitter 122 may digitize the entire 5 MHz band and extract each narrowband transmit channel 108a for separate processing. A wideband digital stream 123 may be communicated from the signal splitter 122 to the at least one wideband waveform processor 124a. For example, where the satellite 112 includes 16 spot beams each including 4 channels (in transmit and receive), totaling 64 wideband channels (in transmit and receive), with each such wideband channel including one or more spectrally notched narrowband channels, the wideband digital stream may correspond to such data transmitted over the 64 wideband channels. Similarly, a narrowband digital stream 125 may be communicated from the signal splitter 122 to the at least one narrowband waveform processor 126a. In embodiments, a plurality of narrowband digital streams 125 may be communicated from the signal splitter 122. The plurality of narrowband digital streams 125 may occur when multiple narrowband transmission waveforms 104a (e.g., 10 to 20 sessions) are concurrently transmitted with each wideband transmission waveform 102a.

The wideband signal and the narrowband signal may then be routed 118 to the satellite ground facility 114b based on the location of terminal 110a and the terminal 110b together with a location of the spot beams of the satellite 112a and satellite 112b. For example, FIG. 2B depicts various routing 118 depending on the signal destination 201 (e.g., based on a location of the terminal 110b). Where the signal destination 201 is included in a spot beam of a downlink satellite (e.g., the satellite 112a acts as both a downlink and an uplink satellite), the routing 118 may include internal routing 202 at the downlink satellite ground facility (e.g., satellite ground facility 114a) for up-linking back to the downlink satellite. Where both the uplink satellite (e.g., satellite 112b) and downlink satellite (e.g., satellite 112a) communicate with the downlink ground facility (e.g., satellite ground facility 114a), the routing 118 may include internal routing at the satellite ground facility 204. Where the spot beam of an uplink satellite (e.g., satellite 112b) includes a Ka band connection from a separate uplink ground facility, such that the uplink ground facility and downlink ground facility are separated, the routing 118 may include routing 206 from the downlink satellite ground facility (e.g., satellite ground facility 114a) to the uplink satellite ground facility (e.g., satellite ground facility 114b). In this regard, the signal may be routed to an appropriate satellite ground facility 114b and satellite 112b for transmission to the terminal 110b.

In embodiments, the satellite ground facility 114b may include at least a wideband waveform processor 124b, a narrowband waveform processor 126b, a narrowband waveform remapper 128, a signal combiner 130 and a Ka band antenna 120b. The satellite ground facility 114b may receive the wideband signals from the routing 118 to the at least one wideband waveform processor 124b. The wideband waveform processor 124b may provide the wideband signals to the signal combiner 130. The satellite ground facility 114b may also receive the narrowband signals from the routing 118 to the at least one narrowband waveform processor 126b. The narrowband waveform processor 126b may provide the narrowband signals to the narrowband waveform remapper 128. The narrowband waveform remapper 128 may be configured to obfuscate the narrowband receive channels 106b by performing a transmission security (TRANSEC) operation, in accordance with one or more embodiments. The narrowband waveform re-mapper 128 may be obfuscation and time aware to place the narrowband waveform 104 at the appropriate place in the appropriate wideband channel 106. The narrowband waveform remapper 128 may then provide the narrowband signals to the signal combiner 130, for combining the narrowband signals with the wideband signals. The signal combiner 130 may then provide the combined signal to the Ka band antenna 120b. The Ka band antenna 120b may then transmit the Ka band uplink transmission 116b to the satellite 112b.

As may be understood, the satellite ground facility 114 (e.g., satellite ground facility 114a or satellite ground facility 114b) may include any current or future ground station, such as, but not limited to, a MUOS ground station.

Information received on several wideband spot beams can be destined for a terminal 110b or multiple terminals 110b. The satellite ground facility 114 (e.g., satellite ground facility 114a or satellite ground facility 114b) may be configured to aggregate the narrowband waveforms for transmission on one or more wideband channels and/or waveforms. For example, if there a multiple 5 kHz channels received from multiple terminals headed to a single destination terminal (e.g., a reporting back scenario), the satellite ground facility may aggregate the narrowband channels into a single narrowband channel with a greater bandwidth. However, placing the narrowband signals on different 5 MHz receive channels, may eliminate interference to terminals attempting to receive signals near beam boundaries.

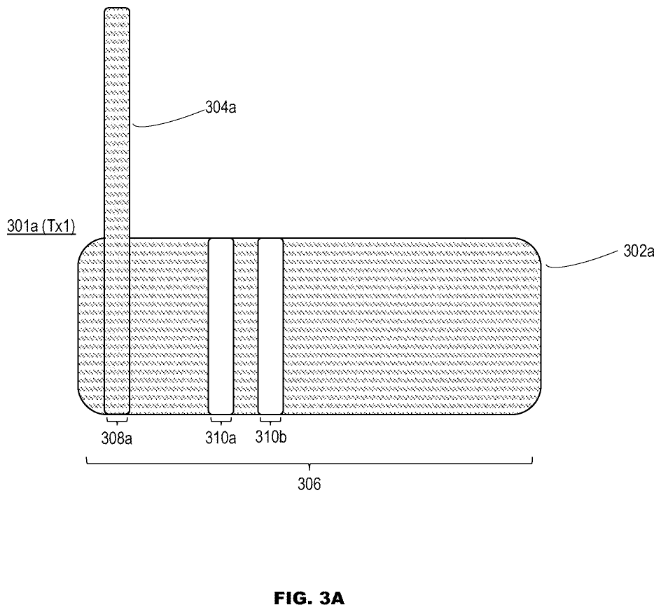

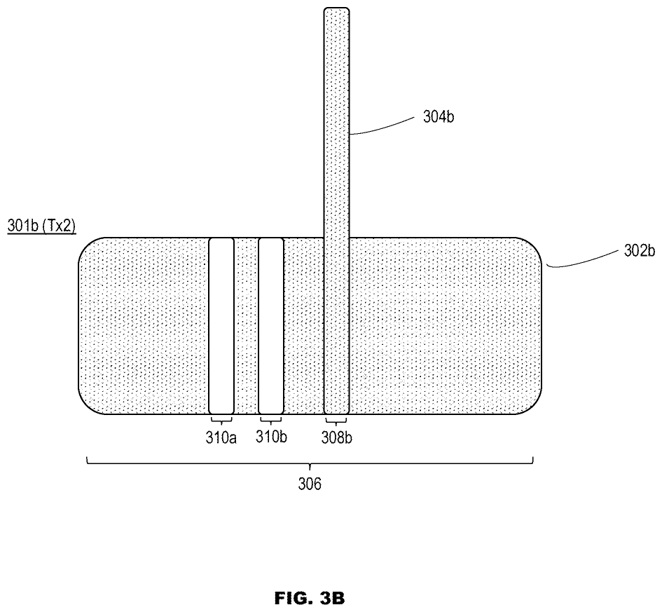

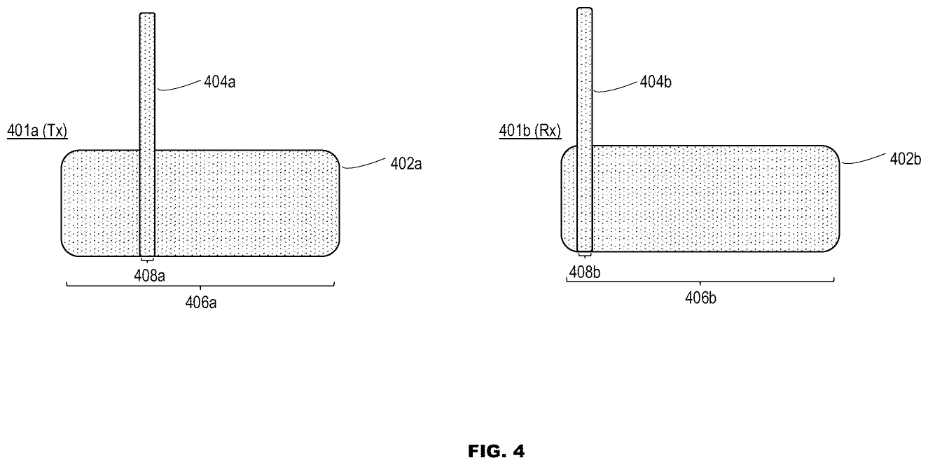

Referring generally to FIGS. 3A-4, one or more obfuscation techniques are described, in accordance with one or more embodiments of the present disclosure.

By utilizing one or more obfuscation techniques described herein, an enemy may be unable to determine a correspondence between the wideband waveform 102 and the narrowband waveform 104. Therefore, the enemy may not effectively jam the narrowband waveform 104 by utilizing a narrowband jamming technique over the narrowband channel 108 together with a wideband jamming technique over the full wideband channel 106. Instead, the enemy must jam all narrowband as well as wideband communication to prevent data transmission. In this regard, the enemy must use significantly more jammer power to prevent the data transmission and/or reception. This may be particularly advantageous, as an enemy platform may have insufficient power to accomplish such jamming. As discussed herein, the transmit obfuscation technique and the receive obfuscation technique may include channel hopping. The transmit obfuscation technique and the receive obfuscation technique need not be the same, but should be coordinated.

FIGS. 3A-3B depict a transmit obfuscation technique, in accordance with one or more embodiments of the present disclosure.

An enemy may be interested in jamming a wideband transmit channel (e.g., wideband transmit channel 106a). Jamming the wideband transmit channel may be difficult as compared to jamming a wideband receive channel (e.g., wideband receive channel 106b) due to a distance between a transmission terminal (e.g., terminal 110a) and a satellite receiving the transmission (e.g., satellite 112a). The enemy may implement wideband transmit channel jamming by high altitude platforms and/or space-based assets, thereby reducing a power needed to deny the wideband transmit waveform to the satellite. In embodiments, channel hopping of the narrowband transmit waveform in the wideband transmit channels may be implemented (e.g., by slow/fast hopping between a plurality of the narrowband transmit channels in the wideband transmit channel). The channel hopping may be implemented by a transmission security (TRANSEC) operation on the terminal (e.g., terminal 110a). By hopping the narrowband transmit waveform between narrowband transmit channels in the wideband channel, a power needed to jam the transmission may be increased.

For example, FIG. 3A depicts a first transmission signal 301a (Tx1) including a first wideband transmit waveform 302a and a first narrowband transmit waveform 304a. The first transmission signal 301a may be transmitted in a wideband transmit channel 306 including spectrally notched first narrowband transmit channel 308a, a first spectrally notched host-nation agreement channel 310a, and a second spectrally notched host-nation agreement channel 310b. The first wideband transmit waveform 302a may be transmitted in the wideband transmit channel 306 concurrently with a first narrowband transmit waveform 304a transmitted in the first narrowband transmit channel 308a. The data carried by the first wideband transmit waveform 302a and the first narrowband transmit waveform 304a may be redundant (e.g., the same), as depicted by the waveform hatching. The first spectrally notched host-nation agreement channel 310a and second spectrally notched host-nation agreement channel 310b may be notched, in accordance with one or more host-nation agreements.

FIG. 3B further depicts a second transmission signal 301b (Tx2) including a second wideband transmit waveform 302b and a second narrowband transmit waveform 304b. The second MUOS transmit waveform 302b is transmitted in the wideband transmit channel 306 concurrently with the second narrowband transmit waveform 304b in a second narrowband transmit channel 308b. The second narrowband transmit channel 308b may be hopped to a portion of the wideband channel different from the first narrowband transmit channel 308a, where the second narrowband transmit channel 308b also does not overlap with the first spectrally-notched host nation agreement channel 310a and the second spectrally-notched host nation agreement channel 310b. The data carried by the second wideband transmit waveform 302b and the second narrowband transmit waveform 304b is the same, as depicted by the waveform hatching, but may be different from the data carried by the first wideband transmit waveform 302a and the first narrowband transmit waveform 304a. Furthermore, the narrowband transmit waveform 304b has hopped from the first narrowband transmit channel 308a to the second narrowband transmit channel 308b. The second narrowband transmit channel 308b may be hopped in accordance with a TRANSEC scheme.

FIG. 4 depicts one or more receive obfuscation techniques, in accordance with one or more embodiments of the present disclosure.

There may be a one-to-one correspondence between a wideband transmit waveform (e.g., wideband transmit waveform 102a) and a wideband receive waveform (e.g., wideband receive waveform 102b), and similarly for a narrowband transmit waveform (e.g., the narrowband transmit waveform 104a) and a narrowband receive waveform (e.g., the narrowband receive waveform 104b). Thus, an enemy observing transmit frequencies of the wideband transmit waveform and the narrowband transmit waveform may determine a frequency of one or more of the wideband receive waveform and/or the narrowband receive waveform. Upon determining the receive frequency, the enemy may jam the receive frequency. To prevent the enemy from determining the receive frequency from the transmit frequency, one or more receive obfuscation techniques may be used. In embodiments, the narrowband receive channel may be shifted to obfuscate a relationship between the narrowband transmit waveforms and the narrowband receive waveforms. In this regard, a location of the narrowband receive channel may be shifted in the wideband receive channel. The receive frequencies of the narrowband receive waveform may be shifted by a transmission security (TRANSEC) scheme. Thus, a relationship between the narrowband transmit channel and the narrowband receive channel may be obfuscated. By obfuscating the narrowband transmit channel and receive channels, an enemy may be prevented from selectively targeting the narrowband receive waveform. The TRANSEC scheme may include statistically shifting the receive frequencies of the narrowband receive waveform 104b. The TRANSEC scheme for obfuscating the narrowband receive waveform may further include frequency hopping (not depicted, see FIGS. 3A-3B for example).

For example, FIG. 4 depicts transmission signal 401a (Tx) and receive signal 401b (Rx) with a statistically shifted narrowband receive frequency. The transmission signal may include a wideband transmit waveform 402a and a narrowband transmit waveform 404a.

The transmission signal 401a may be in a wideband transmit channel 406a including spectrally notched narrowband transmit channel 408a. The wideband transmit waveform 402a may be transmitted in the wideband transmit channel 406a concurrently with the narrowband transmit waveform 404a transmitted in the narrowband transmit channel 408a. The data carried by the wideband transmit waveform 402a and the narrowband transmit waveform 404a is redundant, as depicted by the waveform hatching.

The receive signal 401b may be in a wideband receive channel 406b including spectrally notched narrowband receive channel 408b. The wideband receive waveform 402b may be transmitted in the wideband receive channel 406b concurrently with the narrowband receive waveform 404b transmitted in the narrowband receive channel 408b. The data carried by the wideband receive waveform 402b and the narrowband receive waveform 404b is redundant, as depicted by the waveform hatching, and may be the same as the data carried by the wideband transmit waveform 402a and the narrowband transmit waveform 404a (e.g., because the receive signal has gone through a double hop communication system to reach a desired terminal). However, the narrowband receive channel 408b has been statistically shifted in the wideband receive channel 406b, as compared to the narrowband transmit channel 408a in the wideband transmit channel 406a. As should be understood, the wideband transmit channel 406a is in a channel of the wideband transmit frequency plan and the wideband receive channel 406b is in a channel of the wideband receive frequency plan (see FIG. 1 for example).

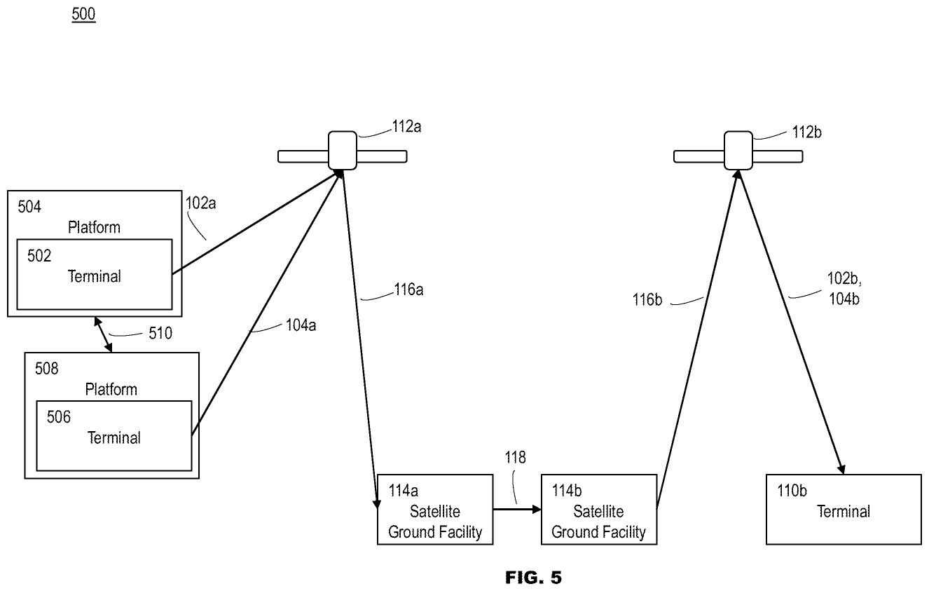

FIG. 5 depicts a system 500, in accordance with one or more embodiments of the present disclosure.

Although much of the disclosure is related to the terminal 110 which is configured to transmit (e.g., terminal 110a) and/or receive (e.g., terminal 110b) both narrowband and wideband communication in the wideband channel 106, this is not intended as a limitation of the present disclosure. To further obfuscate a relationship between the wideband signals and the narrowband signals in the wideband channel, the narrowband signals may be originated from a different platform.

In embodiments, the wideband transmit waveform 102a may originate from a terminal 502 on a first platform 504 and the narrowband transmit waveform 104a may originate from a terminal 506 on a second platform 508. The terminal 502 of the first platform 504 and the terminal 506 of the second platform 508 may be identical to the terminal 110, except that the terminal 502 of the first platform 504 is configured to transmit the wideband transmit waveform 102a in the wideband transmit channel 106a and the terminal 506 of the second platform 508 is configured to transmit the narrowband transmit waveform 104a in the narrowband transmit channel 108a. The wideband terminal 502 and the narrowband terminal 506 may collaborate, such that the wideband terminal 502 spectrally notches narrowband channels in a wideband channel of the terminal, and such that the narrowband terminal 506 transmits narrowband waveforms in the narrowband notches provided by the wideband channel.

The first platform 504 may share the data to be transmitted and the narrowband channel frequency to the second platform 508 by a communication link 510 (e.g., a low probability of intercept/low probability of detection (LPI/LPD)). The terminal 502 of the first platform 504 may then transmit the wideband transmit waveform 102a and the terminal 506 of the second platform 508 may transmit the narrowband transmit waveform 104a. By relaying the communication as described, the message may experience similar anti-jam properties as described in relation to the terminal 110a when transmitting the wideband transmit waveform 102a and the narrowband transmit waveform 104a from the terminal 110a. In addition, the relayed communication may provide additional anti-jam properties by further obfuscating the relationship between the wideband waveform 102a and the narrowband waveform 104a.

For example, the first platform 504 may include an Airborne Warning and Control System (AWACS). The AWACS may use the covert communications link 510 to communicate a copy of the message to be sent with the second platform 508 (e.g., by one or more radios). The second platform 508 may include, but is not limited to, a UAV, a ship, a vehicle, or a fixed site. The terminal 506 of the second platform 508 may include, but is not limited to, an ARC-210 family of radio.

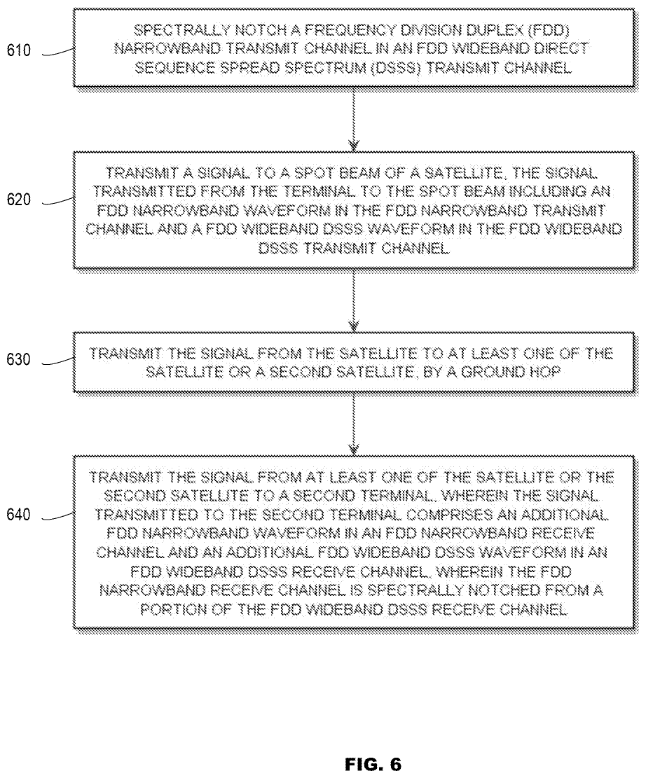

FIG. 6 depicts a method 600, in accordance with one or more embodiments of the present disclosure. The embodiments and the enabling technologies described previously herein in the context of system 100 should be interpreted to extend to the method 600. It is further recognized, however, that the method 600 is not limited to the system 600.

In a step 610, a terminal (e.g., terminal 110a) may spectrally notch a Frequency Division Duplex (FDD) narrowband transmit channel (e.g., narrowband transmit channel 108a) in a Frequency Division Duplex (FDD) wideband Direct Sequence Spread Spectrum (DSSS) transmit channel (e.g., wideband transmit channel 106a).

In a step 620, the terminal may transmit a signal to a spot beam of a satellite (e.g., satellite 112a), the signal transmitted from the terminal to the spot beam including a Frequency Division Duplex (FDD) narrowband waveform (e.g., narrowband waveform 104a) in the narrowband transmit channel and a Frequency Division Duplex (FDD) wideband Direct Sequence Spread Spectrum (DSSS) waveform (e.g., wideband waveform 102a) in the FDD wideband DSSS transmit channel. The FDD narrowband waveform and the FDD wideband DSSS waveform may each include redundant data for improving a jam resistance of the signal. This may be advantageous in improving a jam resistance of the signal.

In a step 630, the signal may be transmitted from the satellite to at least one of the satellite or a second satellite, by a ground hop. The ground hop may include transmitting, by the satellite, a Ka band transmission to a first ground facility. The signal may then optionally be routed to a second ground facility or be routed internally, depending on a destination of the signal (see FIG. 2B, for example). The signal may then be transmitted to at least one of the satellite or a second satellite by an additional Ka band transmission from at least one of the ground facility or the second ground facility.

In a step 640, the signal may be transmitted from at least one of the satellite the second satellite to a second terminal (e.g., terminal 110b). The signal transmitted from the at least one of the satellite or the second satellite to the second terminal may include an additional FDD narrowband waveform (e.g., narrowband waveform 104b) in an FDD narrowband receive channel (e.g., narrowband receive channel 108b) and an additional FDD wideband DSSS waveform (e.g., wideband receive waveform 102b) in an FDD wideband DSSS receive channel (e.g., wideband receive channel 106b). In this regard, the FDD narrowband receive channel may be spectrally notched from a portion of the FDD wideband DSSS receive channel.

Referring generally again to FIGS. 1-6, a system 100 and a method 600 are disclosed, in accordance with one or more embodiments of the present disclosure.

The satellite 112 (e.g., satellite 112a, satellite 112b) may include wideband channels 106 with a high gain-to-noise temperature (G/T) within their spot beams. In this regard, a considerable link margin may be present when narrowband signals are transmitted to the satellite 112a or from the satellite 112b. Assuming minimum feeder link degradation and assuming that all terminals operating in a spot beam of the satellite 112 notch the narrowband channel 108, the terminal 110 may link with the satellite 112 by the narrowband waveform 104 operating in at least one of a Binary Phase Shift Keying (BPSK), a Quadrature Phase Shift Keying (QPSK), a higher-order Phase Shift Keying (e.g., 8-PSK), or a Continuous Phase Modulation (CPM) mode. A relatively low transmission power is needed to close a narrowband link in the wideband channel 106. This may be due, at least in part, to a gain of the satellite 112 spot beam antennas. The narrowband receive waveforms and the narrowband transmit waveforms may include different modes, for obfuscating a relationship between transmit and receive.

Excess margin between the terminal 110 and the satellite 112 may be used at data rates of 32 kbps and below to increase a transmit power of the narrowband waveform 104, without notching, to operate concurrent with the wideband waveform 102. For example, assuming wideband channel 106 loading of 50%, approximately 10 to 14 dB of excess transmit power may be needed to operate above the wideband channel 106 noise and interference.

In embodiments, the terminal 110 may be configured to transmit and/or receive a plurality of the narrowband waveforms 104 in a plurality of the narrowband channels 108 concurrently with the wideband waveform 102. For example, between 10 and 20 sessions of narrowband waveforms 104 may be concurrently transmitted with the wideband waveform 102. In embodiments, at least some of the plurality of narrowband waveforms 104 may carry the same data as the wideband waveform 102 (e.g., for redundancy of essential data) with the remainder of the plurality of narrowband waveforms 104 carrying non-redundant data (e.g., for improving data rates of nonessential data).

In embodiments, the terminal 110b is housed on a fighter aircraft platform (not depicted).

In embodiments, there may be a plurality of wideband transmissions concurrently transmitted in a wideband transmit channel in a spot beam of a satellite (e.g., because of a DSSS spreading code). For example, several users may share the wideband channel by the DSSS spreading code. Where the wideband transmit channel has a bandwidth of 5 MHz, a portion of the wideband channel may be spectrally notched. The spectrally notched portion of the channel may correspond to narrowband channels and/or host nation channels. For example, a total bandwidth of the spectrally notched portion (e.g., narrowband and host nation) of the wideband channel may be less than or equal to 500 kHz. To accommodate the host-nation agreement channels, the wideband channel may include up to 500 kHz of spectrally-notched narrowband channels. Where a plurality of wideband transmissions are concurrently transmitted, each transmission may optionally include one or more narrowband transmissions. However, such narrowband transmissions must not occupy a common spectrum with other narrowband transmissions in the wideband channel to prevent interference. Furthermore, such narrowband transmission must not occupy a common spectrum with the host-nation agreement channels. Thus, a TRANSEC scheme may be used to ensure the narrowband transmissions accompanying the wideband transmissions do not occupy a same portion of the wideband channel as other narrowband transmissions or host-nation transmissions. The TRANSEC scheme may ensure the various wideband channels are notched appropriately. The wideband transmissions may additionally be hopped between narrowband channels of the wideband transmit channel for obfuscating the narrowband transmission by the TRANSEC scheme.

What is claimed:

1. A method for transmitting information comprising:
spectrally notching, by a terminal, a Frequency Division Duplex (FDD) narrowband transmit channel in a FDD wideband Direct Sequence Spread Spectrum (DSSS) transmit channel; and
transmitting a signal from the terminal to a spot beam of a satellite, the signal transmitted from the terminal to the spot beam including an FDD narrowband waveform in the FDD narrowband transmit channel and an FDD wideband DSSS waveform in the FDD wideband DSSS transmit channel, wherein the FDD narrowband waveform and the FDD wideband DSSS waveform each include redundant data for improving a jam resistance of the signal.

2. The method of claim 1, wherein the FDD wideband DSSS transmit channel is in a transmit frequency plan in an Ultra-High Frequency (UHF) band, wherein the FDD wideband DSSS waveform has a bandwidth of greater than or equal to 5 MHz.

3. The method of claim 2, further comprising:
transmitting the signal from the satellite to at least one of the satellite or a second satellite, by a ground hop; and
transmitting the signal from at least one of the satellite or the second satellite to a second terminal, wherein the signal transmitted to the second terminal comprises an additional FDD narrowband waveform in an FDD narrowband receive channel and an additional FDD wideband DSSS waveform in an FDD wideband DSSS receive channel, wherein the FDD narrowband receive channel is spectrally notched from a portion of the FDD wideband DSSS receive channel.

4. The method of claim 3, wherein the FDD wideband DSSS receive channel is in a receive frequency plan in the UHF band, wherein the additional FDD wideband DSSS waveform has a bandwidth of greater than or equal to 5 MHz.

5. The method of claim 4, wherein the FDD narrowband receive channel is shifted in the FDD wideband DSSS receive channel relative to the narrowband transmit channel in the FDD wideband DSSS transmit channel for obfuscating a relationship between the FDD narrowband waveform and the additional FDD narrowband waveform.

6. The method of claim 4, further comprising hopping the additional FDD narrowband waveform between a plurality of FDD narrowband receive channels, wherein the plurality of FDD narrowband receive channels are spectrally notched from the FDD wideband DSSS receive channel.

7. The method of claim 1, wherein the FDD narrowband waveform has a bandwidth of 5 kHz or 25 kHz.

8. The method of claim 1, wherein a portion of the FDD wideband channel from which the FDD narrowband channel is spectrally notched includes a bandwidth of 500 kHz or less.

9. The method of claim 1, wherein spectrally notching the FDD narrowband transmit channel in the FDD wideband DSSS transmit channel further comprises spectrally notching a plurality of FDD narrowband transmit channels in the FDD wideband DSSS transmit channel.

10. The method of claim 9, further comprising hopping the FDD narrowband waveform between the plurality of FDD narrowband transmit channels.

11. The method of claim 9, wherein the signal transmitted from the terminal to the spot beam of the satellite further comprises a plurality of FDD narrowband waveforms in the plurality of FDD narrowband transmit channels, at least some of the plurality of FDD narrowband waveforms including data which is not redundant with the FDD wideband DSSS waveform for improving a data rate of the signal.

12. The method of claim 1, further comprising spectrally notching the FDD wideband DSSS transmit channel in accordance with a host nation agreement.

13. A communication system comprising:
a Frequency Division Duplex (FDD) wideband Direct Sequence Spread Spectrum (DSSS) waveform in a FDD wideband DSSS transmit channel, the FDD wideband DSSS transmit channel including a FDD narrowband transmit channel generated by spectral notching;
a FDD narrowband waveform in the FDD narrowband transmit channel of the FDD wideband DSSS transmit channel;
a first platform including a terminal, the terminal of the first platform configured to transmit the FDD wideband DSSS waveform in the FDD wideband DSSS transmit channel to a satellite and spectrally notch the FDD narrowband transmit channel in the FDD wideband DSSS transmit channel; and
a second platform including a terminal, the terminal of the second platform configured to transmit the FDD narrowband waveform in the FDD narrowband transmit channel,
wherein the FDD wideband DSSS waveform and the FDD narrowband waveform include redundant data.

14. The communication system of claim 1, wherein the first platform is configured to share the FDD narrowband transmit channel and the redundant data with the second platform by a communication link.

15. The communication system of claim 1, wherein the first platform comprises an Airborne Warning and Control System (AWACS).
